(19) United States
(12) Patent Application Publication
(10) Pub. No.: US 2015/0041547 A1
(43) Pub. Date: Feb. 12, 2015

(54) IDENTIFICATION TAG

(71) Applicant: EITS GLOBAL LIMITED SEZC, Grand Cayman (KY)

(72) Inventors: Robert Nicholas Sofoulis, Attadale (AU); David McWilliams, Attadale (AU); Steve Bramley, Attadale (AU)

(21) Appl. No.: 14/376,084

(22) PCT Filed: Jan. 31, 2013
(86) PCT No.: PCT/AU2013/000085

§ 371 Date: Jul. 31, 2014

(30) Foreign Application Priority Data
Jan. 31, 2012 (AU) 2012900353
Oct. 10, 2012 (AU) 2012904429

(51) Int. Cl. G06K 19/077

(52) U.S. Cl. CPC G06K 19/07762; G06K 19/07798
USPC 235/492

(57) ABSTRACT

An identification tag (11) adapted to be worn or secured to an object, the identification tag incorporates an RFID device (13) incorporating a unique identification means, wherein the RFID device is disabled when the identification tag is removed from the item.

### TECHNICAL FIELD

The present invention generally relates to an identification tag. In particular the invention relates to an identification tag capable of storing information thereon.

### BACKGROUND ART

There is a growing need to track movement of objects (e.g. goods, people) in order to provide up to date information in relation to the whereabouts of these objects. The information can also be collected and analysed in order to tailor and adjust services to suit real life requirements.

For example, event organisers and workplace authorities may need to track event attendees/employees to ensure that they are there legitimately, and that they meet their duty of care in relation to the attendees/employees. There are presently no systems available that allow continuous monitoring and updating of attendees/employees movements and actions, ensuring that their proof of authorization is not transferred to another person, and ensuring that the organizer or workplace authority meets their duty of care.

At many events the attendee is provided with a wristband to signify that they are authorized to be in the event or in a particular area of an event. Where conventional wristbands are used to identify authorized attendees the risk exists of unauthorized people counterfeiting wristbands. There is also the risk of authorized attendees transferring their wristbands to other unauthorized people once they have entered the event or workplace. This then leads to potential overcrowding, associated safety issues, and loss of income from the unauthorized people gaining access.

Going hand in hand with these safety and profitability concerns is the need for collecting and using information in a more efficient manner in real time.

Additionally where there is the need for several types of identification to access different areas or services offered at events or in the workplace further, or different means of identification are often required. For example additional wristbands, or wristbands of a different colour may be required to access alcohol serving areas, VIP areas, hazardous materials areas, areas with commercially valuable materials or information etc. This leads to confusion for any one tracking movements as they are required to remember what each different identification means permits the wearer to do.

In the case of most events which utilise wristbands, the attendee receives both a ticket and a security wristband. However, the ticket and wristband are typically provided by different parties which are separate to the event organisers. Typically, the ticket seller would dispatch the tickets and then send a list of the ticket purchasers to the third party, who then in turn dispatches the wristbands. As a result it is extremely difficult to link each individual wristband with its specific ticket, and therefore difficult to track wristbands once dispatched. This therefore allows people to duplicate wrist bands as the wrist bands cannot be identified and therefore disabled. It also allows the purchaser to suggest that they never received the ticket or wristband and ask the organiser to issue a replacement. However, as there is no link between the two items it is impossible for the organiser to cancel one or the other if a purchaser advises that they did not receive one of the items. As a result it is possible that a replacement ticket/wristband may be issued to the purchaser and the purchaser, who did in fact receive both items, on sells the replacement item.

Obviously where wristband identification is in addition to a ticket for entry there exists the extra labour required to print both the ticket and wristband and the extra costs associated with separate manufacture and dispatch.

The preceding discussion of the background art is intended to facilitate an understanding of the present invention only. The discussion is not an acknowledgement or admission that any of the material referred to is or was part of the common general knowledge as at the priority date of the application.

### SUMMARY OF INVENTION

The present invention seeks to ameliorate, mitigate or overcome, at least one disadvantage of the prior art, or which will at least provide the public with a practical choice.

According to an aspect of the present invention, the present invention provides an identification tag adapted to be worn or secured to an object, the identification tag incorporates an RFID device incorporating a unique identification means, wherein the RFID device is disabled when the identification tag is removed from the item.

According to a further aspect of the present invention, the present invention provides an identification tag which in use may be in the form of a wristband adapted to be worn or secured to an object, the wristband including an RFID device incorporating a unique identification means, wherein the RFID device is adapted to be disabled when the wristband is removed from the object. As the integrity of the RFID device is directly dependent on the integrity of the wristband, the successful transfer of the identification tag between objects, such as people is very difficult.

Preferably the wristband is in the form of a strip made from a flexible material such as paper.

Preferably the RFID device includes a RFID chip and an antenna, the antenna including a portion that extends substantially along the length of the wristband whereby the RFID device ceases to work if the wristband is damaged along its longitudinal length. The antenna extending the length of the wristband facilitates the linking of the integrity of the RFID device with the integrity of the wristband.

Preferably the RFID device ceases to work if the wristband is ripped anywhere across its length coinciding with the RFID device.

Preferably the RFID chip is spaced apart from the longitudinal ends of the wristband.

Preferably the RFID device is passive.

Preferably the RFID device is active.

Preferably the RFID device is adapted to interact with a wireless network. By being linked with a wireless network the RFID device can be used to actively track a user's movements, purchases and habits.

Preferably the RFID device's unique identification means interacts with the wireless network to allow information relating to the RFID device to be stored, analysed, updated and sent. This information is used as the tracking information.

In one aspect of the invention the identification tag also includes a first locking means and a second locking means, wherein the first locking means and second locking means engage each other when the wristband is secured to an object. The first locking means and second locking means may incorporate an adhesive to allow the first locking means and second locking means to be stuck together.

The first locking means may be located at a first end of the wristband and the second locking means may be located at the second end of the wristband. The locking means may co-operate to secure the first end of the wristband to the second end of the wristband. The locking means may be in the form of an adhesive, where one end has a sticky surface. The locking means may be in the form of a pin and tab assembly wherein the pin is located at one end and is secured through an aperture in the tab located at the other end of the wristband.

Preferably the first locking means and second locking means are in the form of notches.

Preferably the first locking means and second locking means are in the form of perforations.

Preferably the first locking means and second locking means are damaged when the first and second locking means are disengaged.

Preferably a portion of the RFID device interacts with the first locking means and/or the second locking means such that when the first locking means and second locking means are damaged the RFID device is disabled. Preferably the antenna of the RFID device interacts with the first locking means and/or the second locking means. The first and second locking means when damaged can act to break the RFID device.

In another aspect of the invention the wristband incorporates at least one region of weakness whereupon applying tension to the wristband, once secured to an object, will result in damage to the wristband at the location of the at least one region of weakness.

Preferably the RFID device interacts with the at least one region of weakness such that the RFID device is disabled when the wristband is damaged.

Preferably the antenna of the RFID device traverses the at least one region of weakness such that the antenna is broken upon damage caused to the wristband, disabling the RFID device. The at least one region of weakness may be in the form of a series of perforations across the wristband. The perforations may be in the form of slots/slits formed into the wristband, or may be in the form of sections cut out of the wristband. Preferably the wristbands incorporates multiple regions of weakness along it longitudinal length.

Preferably the identification tag further comprises a removable cover section to seal the RFID device from the object to which the identification tag is secured.

Preferably the identification tag is attached to a ticket so that the ticket and identification tag are produced and distributed as a single item. This obviates purchasers from claiming that either the identification tag or ticket were not delivered and were lost. It also allows the ticket seller to easily link and track the combined ticket and identification tag and to easily assign various permissions to identification tag based on the type of ticket purchased (e.g. VIP, backstage, secured rooms).

Preferably the identification tag is removably attached to the ticket.

Preferably the identification tag and ticket are attached through perforations.

The RFID device may be in the form of an ultra-high frequency (UHF) RFID device

Preferably the ticket includes a first RFID device.

Preferably the RFID device is identical to the RFID device of the identification tag.

Preferably the ticket includes a second RFID device in the form of an ultra-high frequency (UHF) RFID device.

In accordance with a further aspect of the present invention, the present invention provides a ticket including a ticket section and an identification tag adapted to form a wristband, wherein the identification tag includes an RFID device.

Preferably the ticket is paper.

Preferably the identification tag is removably attachable to the ticket.

Preferably the ticket section includes a first RFID device.

Preferably the ticket's RFID device is identical to the RFID device of the identification tag.

Preferably the ticket section includes a second RFID device.

Preferably the second RFID device is a long range RFID device.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a plan view of a identification tag according to a first embodiment of this invention;

FIG. 2 is a plan view of the identification tag of FIG. 1 attached to a ticket;

FIG. 3 is an exploded view of the identification tag of FIG. 1 attached to a ticket;

FIG. 4 is an isometric view of the identification tag of FIG. 1 attached to a ticket;

FIG. 5 is a plan view of an identification tag according to a second embodiment of this invention:

In the drawings like structures are referred to by like numerals throughout the several views. The drawings shown are not necessarily to scale, with emphasis instead generally being placed upon illustrating the principles of the present invention.

### DESCRIPTION OF EMBODIMENTS

Broadly, the invention according to an embodiment of the invention is in the form of an identification tag that can be formed to provide a wristband. The identification tag incorporates an RFID device. The RFID device is disabled if the wristband is ripped across its length.

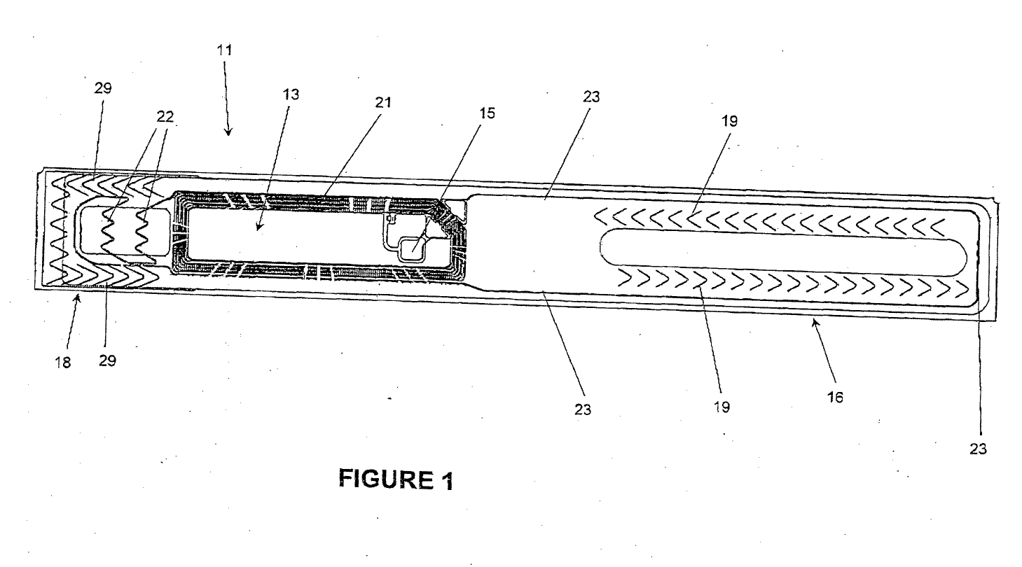

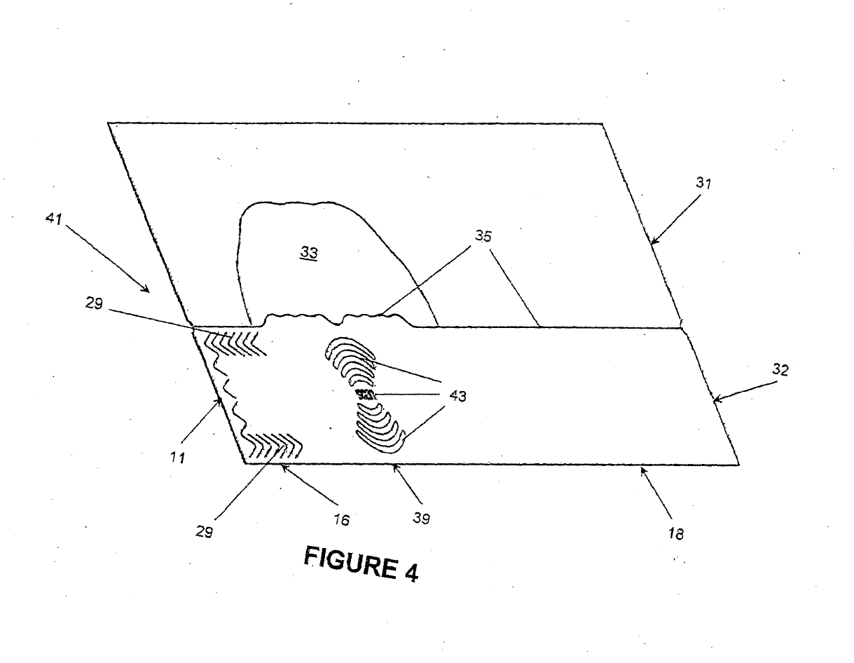

Referring to FIGS. 1 to 4 a first embodiment of the identification tag is shown. In this embodiment the wristband is ideally suited to be worn by an attendee at an entertainment event, such as a music festival. The wristband collects, stores, receives and transmits various information which relates to the attendees activities.

The identification tag is in the form of a wristband 11 having an RFID device 13 incorporated therein. The wristband 11 is typically made of paper and has a long band section 16 and a short band section 18. The short band section 18 has an adhesive section which is adapted to adhere to a portion along the long band section 16 when the wristband 11 is secured around the attendees wrist.

The RFID device 13 includes an RFID transmitter and receiver. Each wristband 11 has a unique RFID identifier used to identify individual attendees at an event.

The RFID device 13 comprises an RFID chip 15 and an antenna circuit 21 which are incorporated in the wristband 11. The antenna circuit 21 comprises antenna sections 22 and 23 which extend in the long band section 16 and short band section 18 of the wristband 11. Hence if the wristband 11 is cut, ripped or torn in any section containing the antenna circuit 21, the data held on the RFID chip 15 will not be retrievable, nor will it be able to receive a signal from a RFID reader and any person using a RFID reader designed to read the RFID chip 15 will know that the wristband has been tampered with due to the circuit being broken.

Although the figures illustrate a long band section 16 and a short band section 18 extending from a region 39 where the chip 15 of the RFID device 13 is located, it is within the scope of this invention for the bands to be of the same length, for there to be only one long band or otherwise.

RFID readers designed to read the RFID chip 15 can be connected through a wireless network, such as Wi-Fi, a 3G or 4G network to transfer RFID data to a central storage hub. The central storage hub can store and update the movements and actions of the attendee wearing the wristband 11 as well as storing their authorizations to different services during its use.

Alternatively the RFID device 13 can be an active RFID device, and data relating to the wristbands movements, authorizations and actions can be stored on the wristband itself.

The wristband 11 include regions of weakness which coincide with the antenna circuit 21. In the embodiment shown, the regions of weakness are in the form of notches 19 on the long band section 16 and notches 29 on the short band section 18. The notches 19, 29 are in the form of v-shaped perforations which increase the likelihood of tearing the wristband and therefore severing the antenna circuit 21 if the wristband was to be removed from the attendees wrist.

If an attendee is able to remove the wristband 11 from their wrist without severing the antenna circuit 21 the notches 19 and 29 are shaped so that the notches 19,29 become noticeably damage so that tampering with the wristband 11 can be identified.

By including RFID identification in the wristband 11, a supplier of the wristband 11 can identify'and regulate who is coming to the event, their movements, their purchases as well as identifying the demographics of the attendees. This not only allows the organisers to provide a safer environment but also provides information which allows targeted marketing and to ensure the appropriate facilities are available at the event.

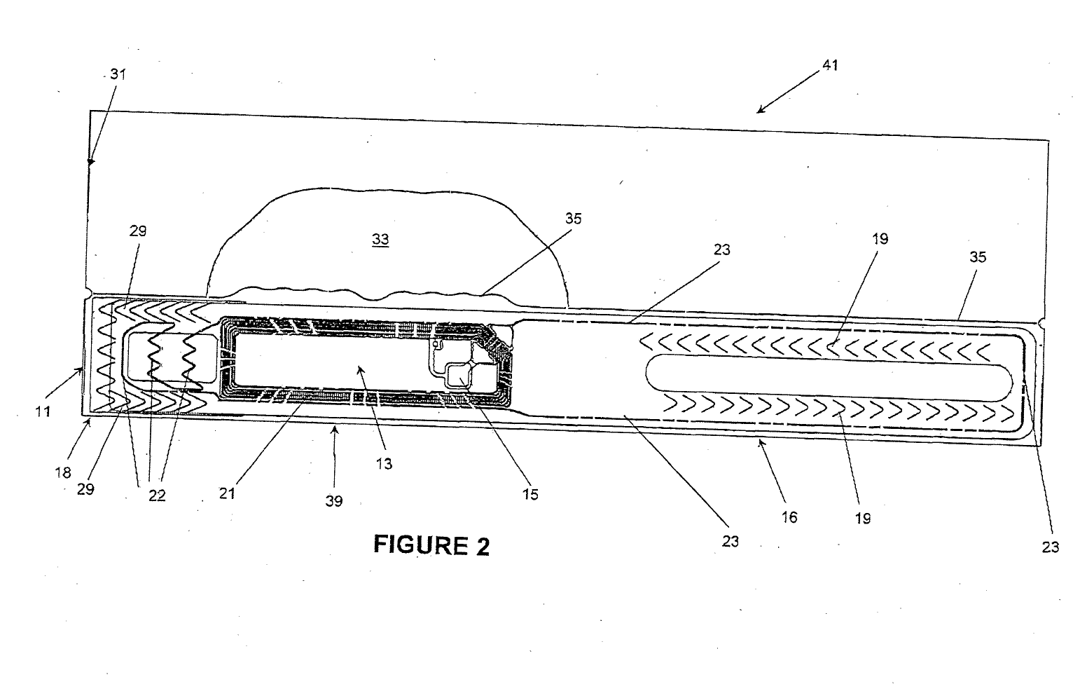

FIGS. 2, 3 and 4 illustrate a ticket 41 with a wristband 11 integral therewith. The ticket 41 can be manufactured to include a ticket section 31 and a removable wristband cover section 32. The ticket can then be supplied to the ticket issuer who can print the required details onto both the wristband 11 and the ticket section 31 before the printed ticket 41 is sent to/collected by the purchaser.

The removable wristband cover section 32 is of the same dimensions and profile as the wristband 11 and seals the RFID circuit from the wristband wearer. The removable wristband cover 32 can be adhered to the wristband 11 through a variety of means, including but not being limited to adhesive, stitching and snap fitting. The ticket section 31 has a printable region 33 that can be printed on with an identifying mark, advertising and/or other indicia.

The wristband 11 is connected to the ticket section 31 along attachment line 35. Attachment line 35 can consist of perforations that allow the wristband 11 to be easily detached from the ticket section 31.

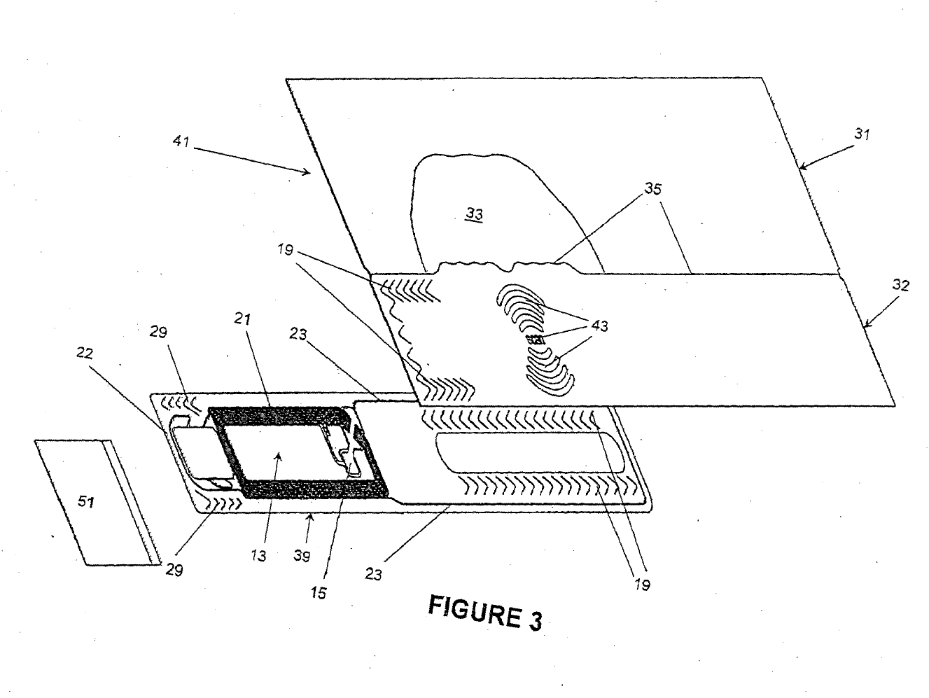

FIG. 3 illustrates an adhesive sticker 51 removably retained to the underside of the wristband 11. Removing the sticker 51 exposes an adhesive surface on the short band section 18 which may adhere to a portion of the long band section 16 as a means of locking the wristband together on the attendee's wrist.

When the wristband is on the attendee's wrist the notches 19, 29 of the short band section 18 and long band section 16 overlap to maintain a region of weakness.

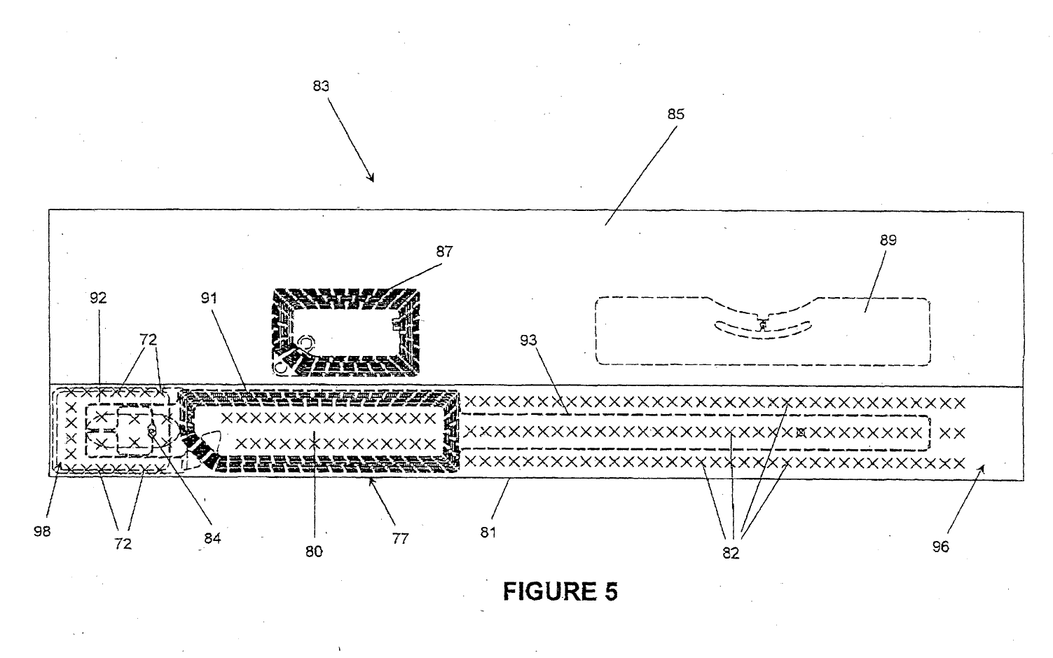

A second embodiment of the invention is illustrated in FIG. 5. FIG. 5 illustrates a wristband 81 attached to a ticket section 85 to form ticket 83. The wristband 81 is illustrated as a paper strip with a RFID device 80 incorporated in it. The RFID device 80 includes an RFID transmitter and receiver. Each wristband 81 has a unique RFID identifier used to identify a particular attendee at a location. An RFID chip 84 and an antenna circuit glare incorporated with the wristband 81. The antenna circuit 91 has antenna sections 92 and 93 which extend in the long band section 96 and short band section 98 of the wristband 81 that are commonly ripped, cut or torn if the wristband is removed from the attendee.

Although FIG. 5 illustrates a long band section 96 and a short band section 98 extending from the region where the RFID device 80 is located, it is within the scope of this invention for the band sections to be of the same length, for there to be only one long band section or otherwise. Hence if the wristband 81 is cut, ripped or torn in any section containing the antenna circuit 91 the data held on the RFID chip 84 will not be retrievable, nor will it be able to receive a signal from a RFID reader and any person using a RFID reader designed to read the RFID chip 84 will know that the wristband has been tampered with due to the circuit being broken (i.e. the RFID device is disabled).

The RFID device 80 can be a high frequency (HF) RFID transmitter and receiver to operate over short distances.

RFID readers designed to read the RFID chip 84 can be connected through a wireless network, such as Wi-Fi, a 3G or 4G network to transfer RFID data to a central storage hub. The central storage hub can store and update the movements and actions of the wristband 81 wearer during its use. Alternatively the RFID transmitter 80 can be an active RFID device, and data relating to the wristbands movements and actions can be stored on the wristband itself.

The wristband 81 differs from the wristband 11 of FIGS. 1 to 4 in that it does not include v-shaped notches 19 on the long band 16 and v-shaped notches 29 on the short band 18. Instead wristband 81 includes weakening regions in the form of cross perforations 82 and 72. When the long band section 96 is locked with the short band section 98 the perforations 82, 72 act as weak points such that the wristband tears between perforations 82, 72 should the wristband undergo a tensile force, such as may be the case when the attendee is removing the wristband form their wrist. The orientation of the perforations 82, 72 encourages any tearing initiated in the perforations 72, 82 to extend beyond the perforations 82, 72. As the antenna circuit 91 weaves between the perforations, the antenna circuit 91 will break, disabling the RFID device should the wristband be torn apart.

A further differing feature between the ticket 41 of FIGS. 1 to 4, and ticket 83 is the incorporation of a different first RFID device 87 and second RFID device 89 therein. The first RFID device 87 is a duplication of RFID device 80. This acts as a safety back up if an attendee loses their wristband 81, allowing the attendee to continue with their activities. The second RFID device 89 on the ticket 83 is an ultra-high frequency (UHF) RFID transmitter and receiver so that it acts over longer distances than RFID devices 80, 87. It is within the scope of the present invention for the second RFID 87 to be a short range RFID device.

While the above invention is described with reference to an RFID device, it cold equally be described with reference to an alternative but suitable transmission and receiving device such as a Near Field Communication device.

Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein. For instance, the wristband,, ticket or ticket section can readily be made of an alternative material to paper as would be understood as appropriate by the skilled addressee.

Reference to positional descriptions, such as lower and upper, are to be taken in context of the embodiments depicted in the figures, and are not to be taken as limiting the invention to the literal interpretation of the term but rather as would be understood by the skilled addressee.

Throughout this specification, unless the context requires otherwise, the word “comprise” or variations such as “comprises” or “comprising”, will be understood to imply the inclusion of a stated integer or group of integers but not the exclusion of any other integer or group of integers.

1. An identification tag adapted to be securely worn or engaged to an object by attaching to itself, the identification tag including a closed circuit RFID device incorporating a unique identification means, wherein the RFID device is adapted to be permanently disabled when the identification tag is removed from its secured engagement with the object or wearer, and wherein the closed circuit extends along the length of the identification tag, so that, once secured to the object or wearer, a portion of the identification tag including the closed circuit overlaps with a second portion of the identification tag that also includes the closed circuit.

2. The identification tag as claimed in claim 1, wherein the identification tag is in the form of a strip made from a flexible material such as paper.

3. The identification tag as claimed in claim 2, wherein the strip forms a wristband.

4. The identification tag as claimed in claim 1, wherein the closed circuit RFID device includes a RFID chip and an antenna; and wherein the antenna includes a portion that extends substantially along the length of the identification tag, whereby the RFID device ceases to work if the identification tag is damaged along its longitudinal length.

5. The identification tag as claimed in claim 2, wherein the RFID device ceases working if the identification tag is ripped across its length coinciding with the RFID device.

6. The identification tag as claimed in claim 3, wherein the closed circuit RFID device includes a RFID chip and an antenna; and wherein the antenna includes a portion that extends substantially along the length of the identification tag, whereby the RFID device ceases to work if the identification tag is damaged along its longitudinal length, wherein the RFID chip is spaced apart from the longitudinal ends of the wristband.

7. The identification tag as claimed in claim 1, wherein the RFID device is a passive RFID device.

8. The identification tag as claimed in claim 1, wherein the RFID device is an active RFID device.

9. The identification tag as claimed in claim 1, wherein the RFID device is adapted to interact with a wireless network.

10. The identification tag as claimed in claim 9, wherein the RFID device's unique identification means interacts with the wireless network to allow information relating to the RFID device to be stored, analysed, updated and sent.

11. The identification tag as claimed in claim 1, including a first locking means and a second locking means, wherein the first locking means and second locking means engage each other when the identification tag is secured to an object.

12. The identification tag as claimed in claim 11, wherein the first locking means and second locking means incorporate an adhesive to allow the first locking means and second locking means to be stuck together.

13. The identification tag as claimed in claim 11, wherein the first locking means is located at a first end of the identification tag and the second locking means is located at a second end of the identification tag.

14. The identification tag as claimed in claim 11, wherein the first and second locking means are in the form of notches or perforations.

15. (canceled)

16. The identification tag as claimed in claim 1, wherein the first and second locking means are damaged when the first and second locking means are disengaged.

17. The identification tag as claimed in claim 11, wherein a portion of the RFID device interacts with the first locking means and/or the second locking means such that when the first locking means and second locking means are damaged the RFID device is disabled.

18. The identification tag as claimed in claim 11, wherein the antenna of the RFID device interacts with the first locking means and/or the second locking means.

19. The identification tag as claimed in claim 11, wherein damage to the first and second locking means acts to break the RFID device.

20. The identification tag as claimed in claim 1, wherein the identification tag incorporates at least one region of weakness, whereupon applying tension to the identification tag, once secured to an object, will result in damage to the identification tag at the location of the at least one region of weakness.

21. The identification tag as claimed in claim 20, wherein the RFID device interacts with the at least one region of weakness such that the RFID device is disabled when the identification tag is damaged.

22. The identification tag as claimed in claim 20, wherein the antenna of the RFID device traverses the at least one region of weakness such that the antenna is broken upon damage being caused to the identification tag, the broken antenna disabling the RFID device.

23. (canceled)

24. (canceled)

25. The identification tag as claimed in claim 2, wherein the strip is attached to a ticket so that the ticket and identification tag are produced or distributed as a single item.

26. The identification tag as claimed in claim 25, wherein the strip is removably attached to the ticket.

27. (canceled)

28. (canceled)

29. The identification tag as claimed in claim 1, wherein the RFID device is in the form of an ultra-high frequency (UHF) RFID device.

30. The identification tag as claimed in claim 25, wherein the ticket includes a printable area.

31. The identification tag as claimed in claim 25, wherein the ticket includes a first RFID device.

32. The identification tag as claimed in claim 31, wherein the first RFID device is identical to the RFID device.

33. The identification tag as claimed in claim 25, wherein the ticket includes a second RFID device.

34. The identification tag as claimed in claim 33, wherein the second RFID device is an ultra-high frequency (UHF) RFID device.

35. A ticket including a ticket section and a distinct identification tag adapted to form a wristband, wherein the identification tag includes a closed circuit ticket RFID device.

36. The ticket as claimed in claim 35, wherein the ticket is paper.

37. The ticket as claimed in claim 35, wherein the identification tag is removably attachable to the ticket.

38. The ticket as claimed in claim 35, wherein the ticket section includes a first ticket RFID device, the first ticket RFID device being identical to the ticket RFID device.

39. (canceled)

40. The ticket as claimed in claim 35, wherein the ticket section includes a second ticket RFID device.

41. The ticket as claimed in claim 40, wherein the second ticket RFID device is a long range RFID device.

42. The ticket as claimed in claim 40, wherein the second ticket RFID device is a UHF RFID device.

43. A ticket including an identification tag as claimed in claim 1.

44. (canceled)
